(19) United States
(12) Patent Application Publication
(10) Pub. No.: US 2022/0226675 A1
(43) Pub. Date: Jul. 21, 2022

(54) METHODS, SYSTEMS, APPARATUSES, AND DEVICES FOR FACILITATING CONTROLLED MOVEMENT ALONG A ROPE

(71) Applicant: Ray Tiongco Vincent, MANILA (PH)

(72) Inventor: Ray Tiongco Vincent, MANILA (PH)

(21) Appl. No.: 17/578,394

(22) Filed: Jan. 18, 2022

Related U.S. Application Data
(60) Provisional application No. 63/138,635, filed on Jan. 18, 2021.

(51) Int. Cl. A62B 1/10

(52) U.S. Cl. CPC A62B 1/10

(57) ABSTRACT

Disclosed herein is an apparatus for facilitating controlled movement along a rope, in accordance with some embodiments. Accordingly, the apparatus comprises a body, a handle, a pulley assembly, and a link. Further, the apparatus is mountable using the handle for loading the rope. Further, the pulley assembly comprises a first fixed pulley, a second fixed pulley, and a movable pulley. Further, the first fixed pulley and the second fixed pulley is fixedly disposed in an interior space of the body and the movable pulley is movably disposed in the interior space. Further, the movable pulley disengaeably engages with the first fixed pulley and the second fixed pulley. Further, the link disengages the movable pulley in a part from the first fixed pulley and the second fixed pulley by moving the movable pulley from a first position to a second position based on receiving an amount of an input force.

The current application claims a priority to the U.S. provisional patent application Ser. No. 63/138,635 filed on Jan. 18, 2021.

### FIELD OF THE INVENTION

Generally, the present disclosure relates to the field of equipment for safety, protection, and rescue. More specifically, the present disclosure relates to methods, systems, apparatuses, and devices for facilitating controlled movement along a rope.

### BACKGROUND OF THE INVENTION

There are less than half a dozen of these gadgets designated as “rope brake” in the market today. These gadgets just regulate or limit the speed of descent of the user/occupant. These gadgets start the descent as soon as the user/occupant rides on them. These just limit the speed of descent, but do not provide the capability to start, change the speed, or stop the descent. One of these gadgets is equipped with the common “centrifugal governor” for control which made it very complicated and expensive to fabricate. Existing gadgets require users to provide for their own body harnesses (but these harnesses take an average of 45 seconds to don, even by experienced construction workers). 45 seconds is just too time-consuming for people in panic situations.

Therefore, there is a need for improved methods, systems, apparatuses, and devices for facilitating controlled movement along a rope that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for facilitating controlled movement along a rope, in accordance with some embodiments. Accordingly, the apparatus may include a body, a handle, a pulley assembly, and a link. Further, the body may include a first side plate and a second side plate spacedly disposed parallel to the first side plate forming an interior space. Further, the handle may include a first handle portion and a second handle portion. Further, a proximal end of the first handle portion may be coupled with the first side plate and a proximal end of the second handle portion may be coupled with the second side plate. Further, the apparatus may be mountable using the handle for loading the rope. Further, a first end of the rope may be secured to at least one immobile object. Further, the pulley assembly may be coupled with the body. Further, the pulley assembly may include a first fixed pulley, a second fixed pulley, and a movable pulley. Further, the first fixed pulley and the second fixed pulley may be fixedly disposed in the interior space and the movable pulley may be movably disposed in the interior space. Further, the first fixed pulley opposes the second fixed pulley. Further, the movable pulley opposes the first fixed pulley and the second fixed pulley. Further, the movable pulley may be configured to be disengaeably engageable with the first fixed pulley and the second fixed pulley. Further, a first channel may be defined between a first wheel of the first fixed pulley and a movable wheel of the movable pulley and a second channel may be defined between a second wheel of the second fixed pulley and the movable wheel based on opposably disposing of the movable pulley in relation to the first fixed pulley and the second fixed pulley. Further, the first fixed pulley may be separated from the second fixed pulley by a predetermined distance defining a passageway between the first fixed pulley and the second fixed pulley. Further, the movable pulley may be movable in the passageway in relation to the first fixed pulley and the second fixed pulley between a first position and at least one second position for disengaeably engaging the movable pulley with the first fixed pulley and the second fixed pulley. Further, the pulley assembly may be configured for coupling with the rope. Further, the rope may be wound around the movable wheel by passing the rope through the first channel and the second channel based on the coupling. Further, the movable pulley engages with the first fixed pulley and the second fixed pulley in the first position based on the loading. Further, the movable wheel unmovably presses the rope against the first wheel and the second wheel based on engaging of the movable pulley with the first fixed pulley and the second fixed pulley. Further, the link may be coupled with the movable pulley. Further, the link may be configured for receiving at least one amount of an input force. Further, the link may be configured for disengaging the movable pulley in at least a part from the first fixed pulley and the second fixed pulley by moving the movable pulley from the first position to the at least one second position based on the receiving of the at least one amount of the input force. Further, the movable wheel movably presses the rope against the first wheel and the second wheel with at least one amount of force for allowing moving the apparatus along a first length of the rope subsequent to the loading with at least one speed corresponding to the at least one amount of the input force based on the moving of the movable pulley in the passageway from the first position to the at least one second position.

Further disclosed herein is an apparatus for facilitating controlled movement along a rope, in accordance with some embodiments. Accordingly, the apparatus may include a body, a handle, a pulley assembly, a link, and a control lever. Further, the body may include a first side plate and a second side plate spacedly disposed parallel to the first side plate forming an interior space. Further, the handle may include a first handle portion and a second handle portion. Further, a proximal end of the first handle portion may be coupled with the first side plate and a proximal end of the second handle portion may be coupled with the second side plate. Further, the apparatus may be mountable using the handle for loading the rope. Further, a first end of the rope may be secured to at least one immobile object. Further, the pulley assembly may be coupled with the body. Further, the pulley assembly may include a first fixed pulley, a second fixed pulley, and a movable pulley. Further, the first fixed pulley and the second fixed pulley may be fixedly disposed in the interior space and the movable pulley may be movably disposed in the interior space. Further, the first fixed pulley opposes the second fixed pulley. Further, the movable pulley opposes the first fixed pulley and the second fixed pulley. Further, the movable pulley may be configured to be disengaeably engageable with the first fixed pulley and the second fixed pulley. Further, a first channel may be defined between a first wheel of the first fixed pulley and a movable wheel of the movable pulley and a second channel may be defined between a second wheel of the second fixed pulley and the movable wheel based on opposably disposing of the movable pulley in relation to the first fixed pulley and the second fixed pulley. Further, the first fixed pulley may be separated from the second fixed pulley by a predetermined distance defining a passageway between the first fixed pulley and the second fixed pulley. Further, the movable pulley may be movable in the passageway in relation to the first fixed pulley and the second fixed pulley between a first position and at least one second position for disengaeably engaging the movable pulley with the first fixed pulley and the second fixed pulley. Further, the pulley assembly may be configured for coupling with the rope. Further, the rope may be wound around the movable wheel by passing the rope through the first channel and the second channel based on the coupling. Further, the movable pulley engages with the first fixed pulley and the second fixed pulley in the first position based on the loading. Further, the movable wheel unmovably presses the rope against the first wheel and the second wheel based on engaging of the movable pulley with the first fixed pulley and the second fixed pulley. Further, the link may be coupled with the movable pulley. Further, the link may be configured for receiving at least one amount of an input force. Further, the link may be configured for disengaging the movable pulley in at least a part from the first fixed pulley and the second fixed pulley by moving the movable pulley from the first position to the at least one second position based on the receiving of the at least one amount of the input force. Further, the movable wheel movably presses the rope against the first wheel and the second wheel with at least one amount of force for allowing moving the apparatus along a first length of the rope subsequent to the loading with at least one speed corresponding to the at least one amount of the input force based on the moving of the movable pulley in the passageway from the first position to the at least one second position. Further, the control lever may be coupled to the body. Further, the control lever may be rotatable about a pivot axis. Further, a distal end of the control lever may be coupled with the link. Further, a proximal end of the control lever receives at least one first input force. Further, the control lever rotates from a first lever position to at least one second lever position about the pivot axis imparting the at least one amount of the input force to the link through the distal end of the control lever based on receiving the at least one first input force. Further, the receiving of the at least one amount of the input force may be based on the imparting.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a side perspective view of an apparatus for facilitating controlled movement along a rope, in accordance with some embodiments.

FIG. 2 is a partial perspective view of the apparatus with the rope, in accordance with some embodiments.

FIG. 3 is a front perspective view of the pulley assembly with the second side plate, in accordance with some embodiments.

FIG. 4 is a side perspective cutout view of the apparatus, in accordance with some embodiments.

FIG. 5 is a side view of the apparatus with the harness, in accordance with some embodiments.

FIG. 6 is a front perspective view of the spool stabilizer of the spool associated with the apparatus, in accordance with some embodiments.

FIG. 7 is a front view of the apparatus with at least one of the first handle portion and the second handle portion in the extended position, in accordance with some embodiments.

FIG. 8 is a front perspective view of the apparatus with at least one of the first handle portion and the second handle portion in the collapsed position, in accordance with some embodiments.

FIG. 9 is a side view of the apparatus with the harness supporting the user, in accordance with some embodiments.

FIG. 10 is a side perspective view of an apparatus for facilitating controlled movement along a rope, in accordance with some embodiments.

FIG. 11 is a side perspective view of an apparatus for facilitating controlled movement along a rope, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating controlled movement along a rope embodiments of the present disclosure are not limited to use only in this context.

### Overview

The present disclosure describes methods, systems, apparatuses, and devices for facilitating controlled movement along a rope.

Further, the present disclosure describes a rope-brake mechanism. Further, the rope-brake mechanism does not include brakes or brake pads. Further, the rope-brake mechanism has added capabilities to start; accelerate; slow down; and stop.

Further, the rope-brake mechanism may include two small fix pulleys are at an ideal distance that when the slightly bigger movable pulley is pulled against the other two, the rope is then stuck between the three pulleys, without slippage. The three pulleys are pinching the rope hard enough without slipping. This happens as soon as the user puts his weight on this gadget while one end of the rope is tied to an overhead structure. This means the weight of the user is holding the user steady before the start of the descent. The descent only starts as the lever on the gadget is moved slightly with one finger. Acceleration or deceleration is done with the same finger moving the lever more or less farther from where it started. Stop ends the descent as soon as the same finger stops operating the lever.

Actual tests on all occasions showed rope tangles form when ropes are thrown from levels as near as four (4) stories below. Each rope comes with a rope guide to prevent tangles. These ropes are 8 mm in diameter with a tensile strength of 1,100 lbs. Each mechanism will come with a rope with each desired length.

A design can just be as simple as a common brake assembly. However, the problem here is the necessity to have brake pads. This mechanism does not need brake pads. Another option is the use of centrifugal governor, but that is a very expensive and complicated proposition. This mechanism may be the utmost in simplicity in this class of gadgets just three small pulleys. In summary, this fire escape gadget allows stop and go motions to avoid obstacles while descending makes it unique in its class.

Further, the rope-brake mechanism may include handlebars, a control lever, and the rope. A link is connected to the control lever to disengage the movable pulley to begin a descent. Further, the movable pulley and the two fixed pulleys may hold the load automatically when the rope is loaded. Further, pulling of the link by the lever will only disengage the movable pulley just enough to begin the descent of a user. Further, the link may also be pulled by another person on the ground in case the user becomes incapacitated or loses consciousness. At other times, when it is just intended to move the rope-brake mechanism manually along the rope, the groove on the link allows that manual movement. Further, the rope-brake mechanism may include a spring to assure that the control lever is pulled back to its starting position, although this is hardly necessary. Further, the load on the rope pulls the movable pulley to merge with fixed pulleys automatically. Further, the rope-brake mechanism may include an easy-to-don harness that may be worn in 3 seconds. Further, the rope-brake mechanism may include the spool stabilizer to assure the rope does not tangle when it is dropped from a height.

Further, the present disclosure describes a gadget intended as a fire escape gadget consisting of three small pulleys. Further, the positioning of the pulleys is such that one would wedge itself against the other two whenever a rope is pulled by its load. Further, the sizing of the pulleys is such that when one is wedged against the other two, it will hold the rope tight enough to prevent slippage. Further, a lever is provided to operate the movable pulley from the two fixed pulleys to start, accelerate, decelerate, or stop a descent. Further, a spool stabilizer is provided to prevent rope tangles when the rope is thrown to levels lower than four (4) stories. This gadget is designed for 100 stories. Further, the lever is provided to detach the movable pulley from the other two to start the descent or stop the descent at any level. Further, a link is provided with a groove to allow manual movement of the mechanism along the rope. Further, two handlebars for both hands are provided to let users hold onto the gadget while descending with or without a harness. Further, a spring is provided to return a major pulley to its initial position in cases where the rope was pulled too far from its normal initial position. Further, a harness is provided which can be worn in three seconds is offered. Further, a triangular hanger is added to hold a belt or a harness. Further, the two handlebars are made collapsible to allow compact storage. Further, a spool stabilizer is provided to prevent a spool from tumbling in mid-air and thereby avert rope tangles as the rope unwinds on its way down.

Further, the present disclosure describes a mechanism that performs as a “rope brake” gadget. As a “rope brake” gadget, the user can start his descent or stop to avoid obstacles along the way and to proceed when safe. A rope, which this mechanism will use for the descent, is attached to a structure. A belt or a seat-and-harness is provided to support a user. This mechanism can save lives whenever people need to lower themselves from high-rise buildings on fire or heavily damaged by earthquakes or forewarned of bomb threats. This invention performs like a rope brake gadget but without brakes or brake pads. There is no comparison because this one is made up of only three small pulleys without brakes or brake pads. Also, unlike the others, it holds the load steady (immobile) before descent, then it is controllable to start down or go faster or slower, and to stop at ground level.

Further, the disclosed apparatus relates generally to mechanisms in helping people descend safely from higher levels to ground level to escape fire or structures damaged by natural calamities. Further, the disclosed apparatus relates generally to mechanisms for lowering persons by means of a line. Further, the present disclosure describes a new controllable apparatus that holds, starts, and stops descent. Therefore, an objective of this disclosed apparatus is to provide the user not only the ability to descend but also to stop when obstacles appear along the way and to proceed when safe. Further, the disclosed apparatus may include a body harness and a seat, which can be worn in about three seconds even by people not familiar with body harnesses. While with this new gadget, the descent does not start immediately, but the user is held steady and immobile while they monitor their pathway regarding obstacles along the way like protruding air conditioners, balconies, etc. before starting their descent. Also, unlike the others, this gadget has the ability to accelerate or decelerate (slow down) and to stop its descent at any point or when the ground is reached.

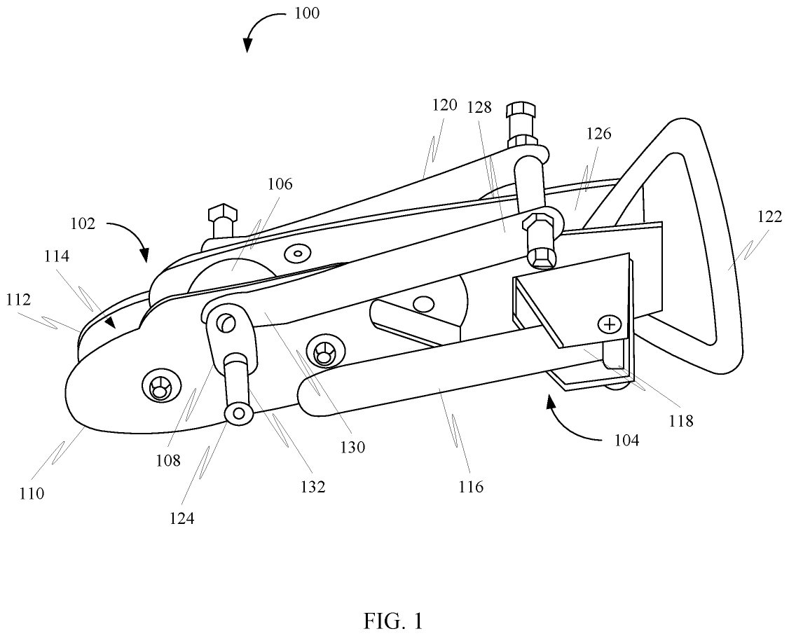

FIG. 1 is a side perspective view of an apparatus 100 for facilitating controlled movement along a rope 202, in accordance with some embodiments. Accordingly, the apparatus 100 may include a body 102, a handle 104, a pulley assembly 106, and a link 108.

Further, the body 102 may include a first side plate 110 and a second side plate 112 spacedly disposed parallel to the first side plate 110 forming an interior space 114.

Further, the handle 104 may include a first handle portion 116 and a second handle portion 402. Further, a proximal end 118 of the first handle portion 116 may be coupled with the first side plate 110 and a proximal end 404 of the second handle portion 402 may be coupled with the second side plate 112. Further, the apparatus 100 may be mountable using the handle 104 for loading the rope 202. Further, a first end 506 of the rope 202 may be secured to at least one immobile object 504.

Further, the pulley assembly 106 may be coupled with the body 102. Further, the pulley assembly 106 may include a first fixed pulley 302, a second fixed pulley 304, and a movable pulley 306. Further, the first fixed pulley 302 and the second fixed pulley 304 may be fixedly disposed in the interior space 114 and the movable pulley 306 may be movably disposed in the interior space 114. Further, the first fixed pulley 302 opposes the second fixed pulley 304. Further, the movable pulley 306 opposes the first fixed pulley 302 and the second fixed pulley 304. Further, the movable pulley 306 may be configured to be disengaeably engageable with the first fixed pulley 302 and the second fixed pulley 304. Further, a first channel 308 may be defined between a first wheel 310 of the first fixed pulley 302 and a movable wheel 312 of the movable pulley 306 and a second channel 314 may be defined between a second wheel 316 of the second fixed pulley 304 and the movable wheel 312 based on opposably disposing of the movable pulley 306 in relation to the first fixed pulley 302 and the second fixed pulley 304. Further, the first fixed pulley 302 may be separated from the second fixed pulley 304 by a predetermined distance defining a passageway 318 between the first fixed pulley 302 and the second fixed pulley 304. Further, the movable pulley 306 may be movable in the passageway 318 in relation to the first fixed pulley 302 and the second fixed pulley 304 between a first position and at least one second position for disengaeably engaging the movable pulley 306 with the first fixed pulley 302 and the second fixed pulley 304. Further, the pulley assembly 106 may be configured for coupling with the rope 202. Further, the rope 202 may be wound around the movable wheel 312 by passing the rope 202 through the first channel 308 and the second channel 314 based on the coupling. Further, the movable pulley 306 engages with the first fixed pulley 302 and the second fixed pulley 304 in the first position based on the loading. Further, the movable wheel 312 unmovably presses the rope 202 against the first wheel 310 and the second wheel 316 based on engaging of the movable pulley 306 with the first fixed pulley 302 and the second fixed pulley 304.

Further, the link 108 may be coupled with the movable pulley 306. Further, the link 108 may be configured for receiving at least one amount of an input force. Further, the link 108 may be configured for disengaging the movable pulley 306 in at least a part from the first fixed pulley 302 and the second fixed pulley 304 by moving the movable pulley 306 from the first position to the at least one second position based on the receiving of the at least one amount of the input force. Further, the movable wheel 312 movably presses the rope 202 against the first wheel 310 and the second wheel 316 with at least one amount of force for allowing moving the apparatus 100 along a first length of the rope 202 subsequent to the loading with at least one speed corresponding to the at least one amount of the input force based on the moving of the movable pulley 306 in the passageway 318 from the first position to the at least one second position.

In further embodiments, the apparatus 100 may include a control lever 120 coupled to the body 102. Further, the control lever 120 may be rotatable about a pivot axis. Further, a distal end 130 of the control lever 120 may be coupled with the link 108. Further, a proximal end 128 of the control lever 120 receives at least one first input force. Further, the control lever 120 rotates from a first lever position to at least one second lever position about the pivot axis imparting the at least one amount of the input force to the link 108 through the distal end 130 of the control lever 120 based on receiving the at least one first input force. Further, the receiving of the at least one amount of the input force may be based on the imparting.

In further embodiments, the apparatus 100 may include at least one spring 406 coupled with the control lever 120 and the body 102. Further, a first end of the at least one spring 406 may be attached to the proximal end 128 of the control lever 120 and a second end may be attached to at least one of the first side plate 110 and the second side plate 112. Further, the at least one spring 406 rotates the lever from the at least one second lever position to the first lever position after a removal of the at least one first input force.

Further, in some embodiments, the first fixed pulley 302 may be rotatable around a first axis perpendicular to at least one of the first side plate 110 and the second side plate 112. Further, the second fixed pulley 304 may be rotatable around a second axis perpendicular to at least one of the first side plate 110 and the second side plate 112. Further, the movable pulley 306 may be rotatable around a third axis perpendicular to at least one of the first side plate 110 and the second side plate 112.

Further, in some embodiments, a first fixed end (320 and 322) of a fixed axel (324 and 326) of each of the first fixed pulley 302 and the second fixed pulley 304 may be fixedly coupled to the first side plate 110 and a second fixed end of the fixed axel (324 and 326) of each of the first fixed pulley 302 and the second fixed pulley 304 may be fixedly coupled to the second side plate 112. Further, a first movable end 328 of a movable axel 330 of the movable pulley 306 may be movably coupled with the first side plate 110 and a second movable end of the movable axel 330 of the movable pulley 306 may be movably coupled with the second side plate 112.

Further, in an embodiment, the first side plate 110 may include a first opening 204 and the second side plate 112 may include a second opening. Further, the first movable end 328 of the movable axel 330 of the movable pulley 306 may be movably disposed in the first opening 204 and the second movable end of the movable axel 330 of the movable pulley 306 may be movably disposed in the second opening.

In further embodiments, the apparatus 100 may include a hanger 122 coupled with the body 102. Further, the hanger 122 may be attached to a distal end 126 of the body 102. Further, the hanger 122 may be configured for attaching at least one equipment to the body 102. Further, the loading of the rope 202 may be based on the attaching.

Further, in an embodiment, the at least one equipment may include a harness 502. Further, the harness 502 may be configured for providing a support to a user 902 mounting the apparatus 100.

In further embodiments, the apparatus 100 may include a spool stabilizer 604 for a spool 602. Further, a second length of the rope 202 may be wound around the spool 602. Further, at least a portion of the second length of the rope 202 may be transformed to at least a portion of the first length of the rope 202 by unwinding the at least one the portion of the second length of the rope 202. Further, the spool stabilizer 604 may be configured for preventing tangling of the at least the portion of the first length of the rope 202 based on the unwinding of the at least one the portion of the second length of the rope 202.

Further, in some embodiments, at least one of the first handle portion 116 and the second handle portion 402 may be configured for transitioning between an extended position and a collapsed position. Further, the first handle portion 116 may be parallelly disposed over the first side plate 110 and the second handle portion 402 may be parallelly disposed over the second side plate 112 in the collapsed position. Further, the first handle portion 116 extends perpendicularly away from the first side plate 110 and the second handle portion 402 extends perpendicularly away from the second side plate 112 in the extended position.

Further, in some embodiments, the link 108 may include at least one groove 124 in a distal portion 132 of the link 108. Further, the at least one groove 124 may be configured for receiving at least one input action from a user. Further, the receiving of the at least one amount of the input force may be based on the receiving of the at least one input action.

Further, in some embodiments, the movable wheel 312 of the movable pulley 306 may be associated with a movable wheel diameter. Further, the movable wheel diameter may be greater than the predetermined distance for allowing wedging of the movable pulley 306 against the first fixed pulley 302 and the second fixed pulley 304 in the first position. Further, unmovably pressing of the rope 202 against the first wheel 310 and the second wheel 316 by the movable wheel 312 may be based on wedging.

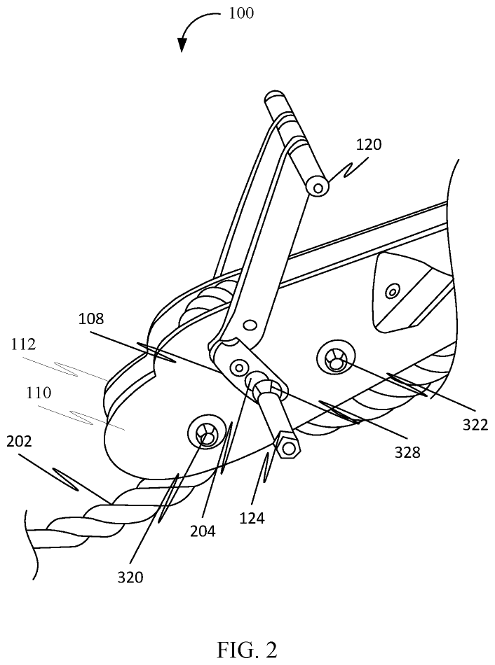

FIG. 2 is a partial perspective view of the apparatus 100 with the rope 202, in accordance with some embodiments.

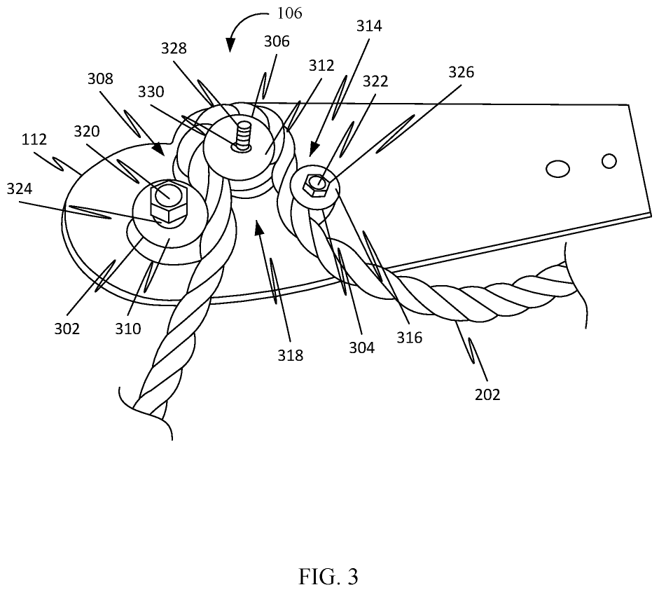

FIG. 3 is a front perspective view of the pulley assembly 106 with the second side plate 112, in accordance with some embodiments.

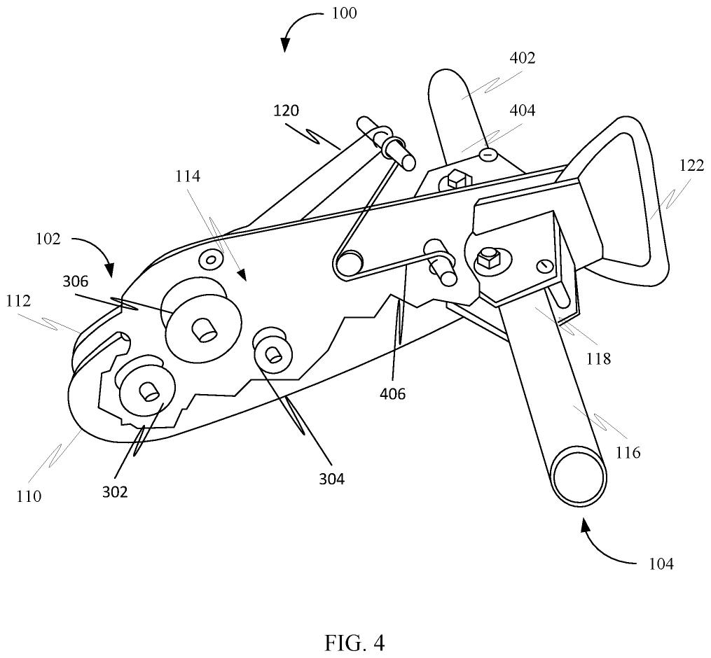

FIG. 4 is a side perspective cutout view of the apparatus 100, in accordance with some embodiments.

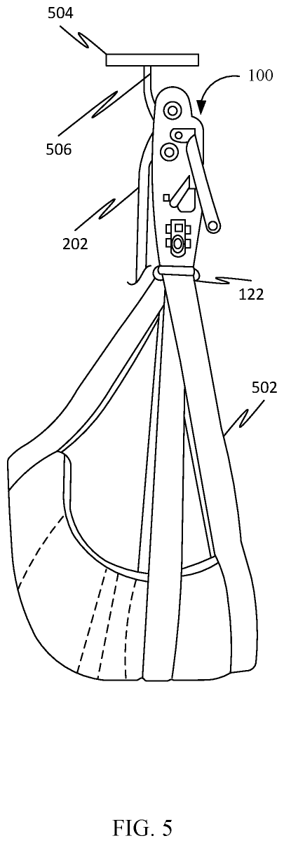

FIG. 5 is a side view of the apparatus 100 with the harness 502, in accordance with some embodiments.

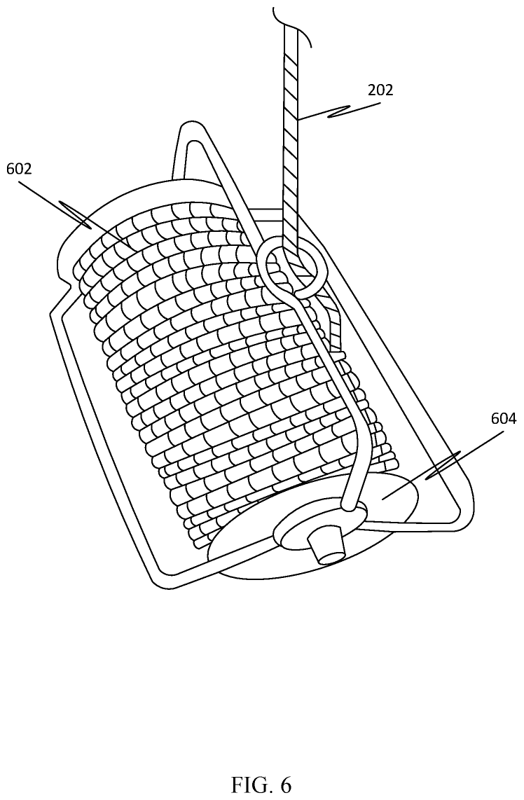

FIG. 6 is a front perspective view of the spool stabilizer 604 of the spool 602 associated with the apparatus 100, in accordance with some embodiments.

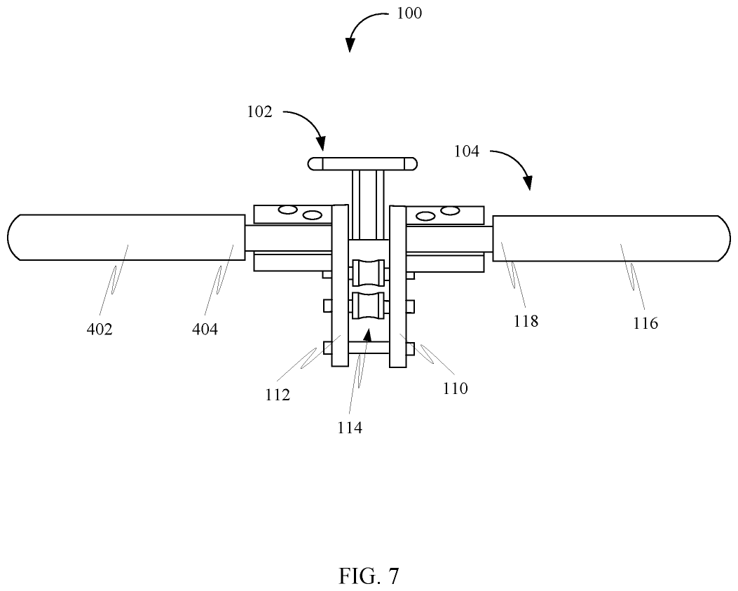

FIG. 7 is a front view of the apparatus 100 with at least one of the first handle portion 116 and the second handle portion 402 in the extended position, in accordance with some embodiments.

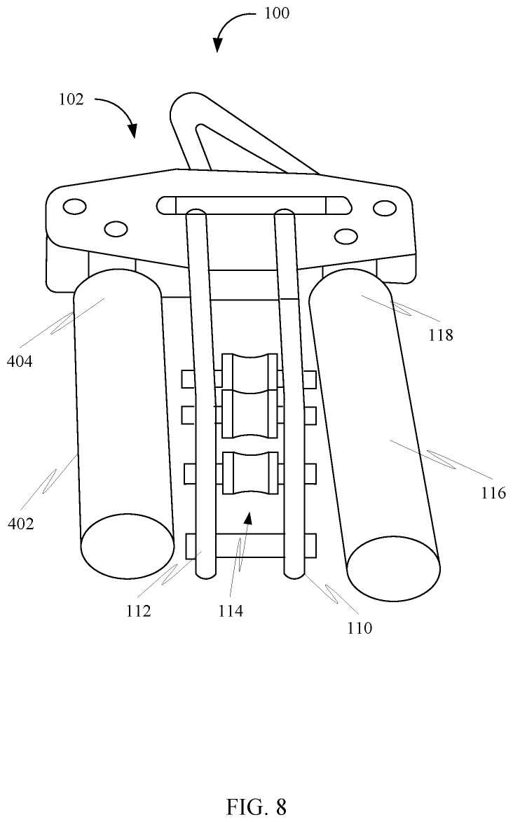

FIG. 8 is a front perspective view of the apparatus 100 with at least one of the first handle portion 116 and the second handle portion 402 in the collapsed position, in accordance with some embodiments.

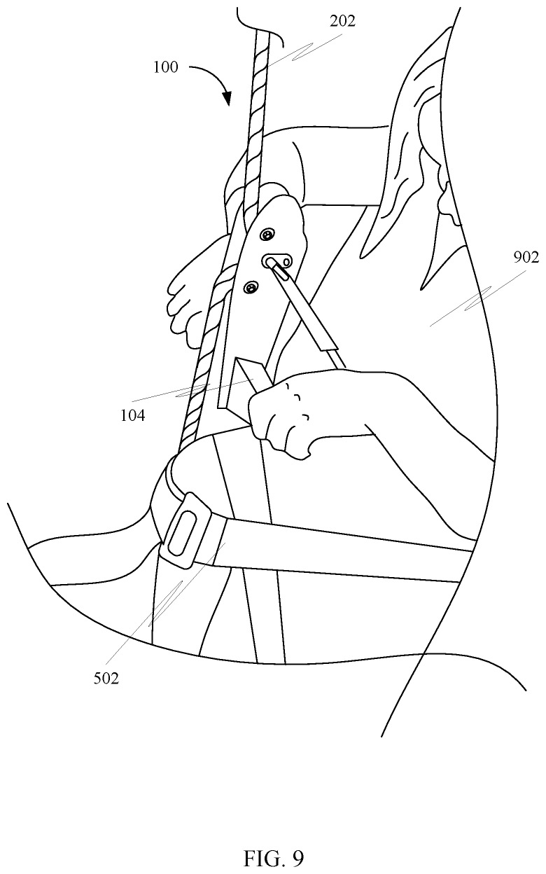

FIG. 9 is a side view of the apparatus 100 with the harness 502 supporting the user 902, in accordance with some embodiments.

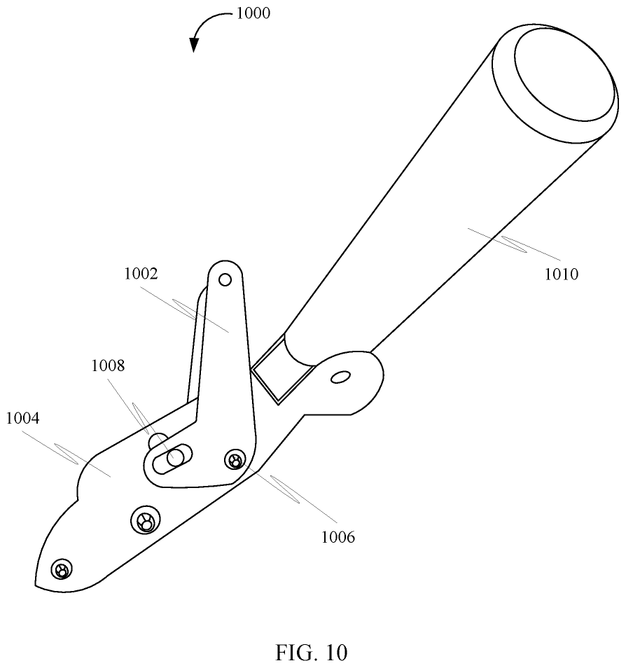

FIG. 10 is a side perspective view of an apparatus 1000 for facilitating controlled movement along a rope, in accordance with some embodiments. Accordingly, the apparatus 1000 may include a body 1004, a lever 1002, a handle 1010, a movable pulley, a first fixed pulley, and a second fixed pulley. Further, the lever 1002 may be pivotally coupled with the body 1004 using a fulcrum 1006. Further, the lever 1002 may be coupled with an axel 1008 of the movable pulley.

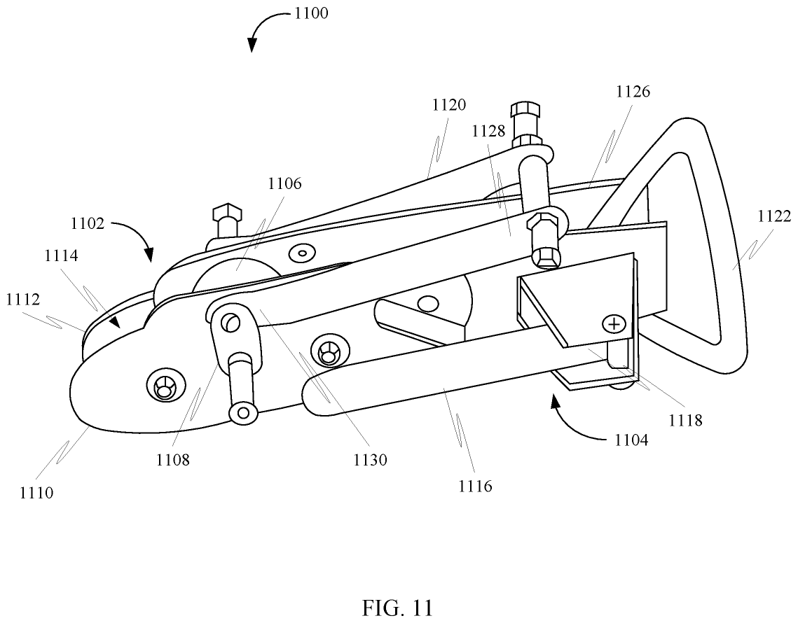

FIG. 11 is a side perspective view of an apparatus 1100 for facilitating controlled movement along a rope, in accordance with some embodiments. Accordingly, the apparatus 1100 may include a body 1102, a handle 1104, a pulley assembly 1106, a link 1108, and a control lever 1120. Further, the body 1102 may include a first side plate 1110 and a second side plate 1112 spacedly disposed parallel to the first side plate 1110 forming an interior space 1114. Further, the handle 1104 may include a first handle portion 1116 and a second handle portion. Further, a proximal end 1118 of the first handle portion 1116 may be coupled with the first side plate 1110 and a proximal end of the second handle portion may be coupled with the second side plate 1112. Further, the apparatus 1100 may be mountable using the handle 1104 for loading the rope. Further, a first end of the rope may be secured to at least one immobile object. Further, the pulley assembly 1106 may be coupled with the body 1102. Further, the pulley assembly 1106 may include a first fixed pulley, a second fixed pulley, and a movable pulley. Further, the first fixed pulley and the second fixed pulley may be fixedly disposed in the interior space 1114 and the movable pulley may be movably disposed in the interior space 1114. Further, the first fixed pulley opposes the second fixed pulley. Further, the movable pulley opposes the first fixed pulley and the second fixed pulley. Further, the movable pulley may be configured to be disengaeably engageable with the first fixed pulley and the second fixed pulley. Further, a first channel may be defined between a first wheel of the first fixed pulley and a movable wheel of the movable pulley and a second channel may be defined between a second wheel of the second fixed pulley and the movable wheel based on opposably disposing of the movable pulley in relation to the first fixed pulley and the second fixed pulley. Further, the first fixed pulley may be separated from the second fixed pulley by a predetermined distance defining a passageway between the first fixed pulley and the second fixed pulley. Further, the movable pulley may be movable in the passageway in relation to the first fixed pulley and the second fixed pulley between a first position and at least one second position for disengaeably engaging the movable pulley with the first fixed pulley and the second fixed pulley. Further, the pulley assembly 1106 may be configured for coupling with the rope. Further, the rope may be wound around the movable wheel by passing the rope through the first channel and the second channel based on the coupling. Further, the movable pulley engages with the first fixed pulley and the second fixed pulley in the first position based on the loading. Further, the movable wheel unmovably presses the rope against the first wheel and the second wheel based on engaging of the movable pulley with the first fixed pulley and the second fixed pulley. Further, the link 1108 may be coupled with the movable pulley. Further, the link 1108 may be configured for receiving at least one amount of an input force. Further, the link 1108 may be configured for disengaging the movable pulley in at least a part from the first fixed pulley and the second fixed pulley by moving the movable pulley from the first position to the at least one second position based on the receiving of the at least one amount of the input force. Further, the movable wheel movably presses the rope against the first wheel and the second wheel with at least one amount of force for allowing moving the apparatus 1100 along a first length of the rope subsequent to the loading with at least one speed corresponding to the at least one amount of the input force based on the moving of the movable pulley in the passageway from the first position to the at least one second position. Further, the control lever 1120 may be coupled to the body 1102. Further, the control lever 1120 may be rotatable about a pivot axis. Further, a distal end 1130 of the control lever 1120 may be coupled with the link 1108. Further, a proximal end 1128 of the control lever 1120 receives at least one first input force. Further, the control lever 1120 rotates from a first lever position to at least one second lever position about the pivot axis imparting the at least one amount of the input force to the link 1108 through the distal end 1130 of the control lever 1120 based on receiving the at least one first input force. Further, the receiving of the at least one amount of the input force may be based on the imparting.

In further embodiments, the apparatus 1100 may include at least one spring coupled with the control lever 1120 and the body 1102. Further, a first end of the at least one spring may be attached to the proximal end 1128 of the control lever 1120 and a second end may be attached to at least one of the first side plate 1110 and the second side plate 1112. Further, the at least one spring rotates the lever from the at least one second lever position to the first lever position after a removal of the at least one first input force.

Further, in some embodiments, the first fixed pulley may be rotatable around a first axis perpendicular to at least one of the first side plate 1110 and the second side plate 1112. Further, the second fixed pulley may be rotatable around a second axis perpendicular to at least one of the first side plate 1110 and the second side plate 1112. Further, the movable pulley may be rotatable around a third axis perpendicular to at least one of the first side plate 1110 and the second side plate 1112.

Further, in some embodiments, a first fixed end of a fixed axel of each of the first fixed pulley and the second fixed pulley may be fixedly coupled to the first side plate 1110 and a second fixed end of the fixed axel of each of the first fixed pulley and the second fixed pulley may be fixedly coupled to the second side plate 1112. Further, a first movable end of a movable axel of the movable pulley may be movably coupled with the first side plate 1110 and a second movable end of the movable axel of the movable pulley may be movably coupled with the second side plate 1112.

In further embodiments, the apparatus 1100 may include a hanger 1122 coupled with the body 1102. Further, the hanger 1122 may be attached to a distal end 1126 of the body 1102. Further, the hanger 1122 may be configured for attaching at least one equipment to the body 1102. Further, the loading of the rope may be further based on the attaching.

In further embodiments, the apparatus 1100 may include a spool stabilizer for a spool. Further, a second length of the rope may be wound around the spool. Further, at least a portion of the second length of the rope may be transformed to at least a portion of the first length of the rope by unwinding the at least one the portion of the second length of the rope. Further, the spool stabilizer may be configured for preventing tangling of the at least the portion of the first length of the rope based on the unwinding of the at least one the portion of the second length of the rope.

Further, in some embodiments, at least one of the first handle portion 1116 and the second handle portion may be configured for transitioning between an extended position and a collapsed position. Further, the first handle portion 1116 may be parallelly disposed over the first side plate 1110 and the second handle portion may be parallelly disposed over the second side plate 1112 in the collapsed position. Further, the first handle portion 1116 extends perpendicularly away from the first side plate 1110 and the second handle portion extends perpendicularly away from the second side plate 1112 in the extended position.

Further, in some embodiments, the movable wheel of the movable pulley may be associated with a movable wheel diameter. Further, the movable wheel diameter may be greater than the predetermined distance for allowing wedging of the movable pulley against the first fixed pulley and the second fixed pulley in the first position. Further, unmovably pressing of the rope against the first wheel and the second wheel by the movable wheel may be based on wedging.

Although the present disclosure has been explained in relation to its preferred embodiment, it is to be understood that many other possible modifications and variations can be made without departing from the spirit and scope of the disclosure.

What is claimed is:

1. An apparatus for facilitating controlled movement along a rope, the apparatus comprising:
a body comprising a first side plate and a second side plate spacedly disposed parallel to the first side plate forming an interior space;
a handle comprising a first handle portion and a second handle portion, wherein a proximal end of the first handle portion is coupled with the first side plate and a proximal end of the second handle portion is coupled with the second side plate, wherein the apparatus is mountable using the handle for loading the rope, wherein a first end of the rope is secured to at least one immobile object;
a pulley assembly coupled with the body, wherein the pulley assembly comprises a first fixed pulley, a second fixed pulley, and a movable pulley, wherein the first fixed pulley and the second fixed pulley are fixedly disposed in the interior space and the movable pulley is movably disposed in the interior space, wherein the first fixed pulley opposes the second fixed pulley, wherein the movable pulley opposes the first fixed pulley and the second fixed pulley, wherein the movable pulley is configured to be disengaeably engageable with the first fixed pulley and the second fixed pulley, wherein a first channel is defined between a first wheel of the first fixed pulley and a movable wheel of the movable pulley and a second channel is defined between a second wheel of the second fixed pulley and the movable wheel based on opposably disposing of the movable pulley in relation to the first fixed pulley and the second fixed pulley, wherein the first fixed pulley is separated from the second fixed pulley by a predetermined distance defining a passageway between the first fixed pulley and the second fixed pulley, wherein the movable pulley is movable in the passageway in relation to the first fixed pulley and the second fixed pulley between a first position and at least one second position for disengaeably engaging the movable pulley with the first fixed pulley and the second fixed pulley, wherein the pulley assembly is configured for coupling with the rope, wherein the rope is wound around the movable wheel by passing the rope through the first channel and the second channel based on the coupling, wherein the movable pulley engages with the first fixed pulley and the second fixed pulley in the first position based on the loading, wherein the movable wheel unmovably presses the rope against the first wheel and the second wheel based on engaging of the movable pulley with the first fixed pulley and the second fixed pulley; and
a link coupled with the movable pulley, wherein the link is configured for receiving at least one amount of an input force, wherein the link is configured for disengaging the movable pulley in at least a part from the first fixed pulley and the second fixed pulley by moving the movable pulley from the first position to the at least one second position based on the receiving of the at least one amount of the input force, wherein the movable wheel movably presses the rope against the first wheel and the second wheel with at least one amount of force for allowing moving the apparatus along a first length of the rope subsequent to the loading with at least one speed corresponding to the at least one amount of the input force based on the moving of the movable pulley in the passageway from the first position to the at least one second position.

2. The apparatus of claim 1 further comprising a control lever coupled to the body, wherein the control lever is rotatable about a pivot axis, wherein a distal end of the control lever is coupled with the link, wherein a proximal end of the control lever receives at least one first input force, wherein the control lever rotates from a first lever position to at least one second lever position about the pivot axis imparting the at least one amount of the input force to the link through the distal end of the control lever based on receiving the at least one first input force, wherein the receiving of the at least one amount of the input force is based on the imparting.

3. The apparatus of claim 2 further comprising at least one spring coupled with the control lever and the body, wherein a first end of the at least one spring is attached to the proximal end of the control lever and a second end is attached to at least one of the first side plate and the second side plate, wherein the at least one spring rotates the lever from the at least one second lever position to the first lever position after a removal of the at least one first input force.

4. The apparatus of claim 1, wherein the first fixed pulley is rotatable around a first axis perpendicular to at least one of the first side plate and the second side plate, wherein the second fixed pulley is rotatable around a second axis perpendicular to at least one of the first side plate and the second side plate, wherein the movable pulley is rotatable around a third axis perpendicular to at least one of the first side plate and the second side plate.

5. The apparatus of claim 1, wherein a first fixed end of a fixed axel of each of the first fixed pulley and the second fixed pulley is fixedly coupled to the first side plate and a second fixed end of the fixed axel of each of the first fixed pulley and the second fixed pulley is fixedly coupled to the second side plate, wherein a first movable end of a movable axel of the movable pulley is movably coupled with the first side plate and a second movable end of the movable axel of the movable pulley is movably coupled with the second side plate.

6. The apparatus of claim 5, wherein the first side plate comprises a first opening and the second side plate comprises a second opening, wherein the first movable end of the movable axel of the movable pulley is movably disposed in the first opening and the second movable end of the movable axel of the movable pulley is movably disposed in the second opening.

7. The apparatus of claim 1 further comprising a hanger coupled with the body, wherein the hanger is attached to a distal end of the body, wherein the hanger is configured for attaching at least one equipment to the body, wherein the loading of the rope is further based on the attaching.

8. The apparatus of claim 7, wherein the at least one equipment comprises a harness, wherein the harness is configured for providing a support to a user mounting the apparatus.

9. The apparatus of claim 1 further comprising a spool stabilizer for a spool, wherein a second length of the rope is wound around the spool, wherein at least a portion of the second length of the rope is transformed to at least a portion of the first length of the rope by unwinding the at least one the portion of the second length of the rope, wherein the spool stabilizer is configured for preventing tangling of the at least the portion of the first length of the rope based on the unwinding of the at least one the portion of the second length of the rope.

10. The apparatus of claim 1, wherein at least one of the first handle portion and the second handle portion is configured for transitioning between an extended position and a collapsed position, wherein the first handle portion is parallelly disposed over the first side plate and the second handle portion is parallelly disposed over the second side plate in the collapsed position, wherein the first handle portion extends perpendicularly away from the first side plate and the second handle portion extends perpendicularly away from the second side plate in the extended position.

11. The apparatus of claim 1, wherein the link comprises at least one groove in a distal portion of the link, wherein the at least one groove is configured for receiving at least one input action from a user, wherein the receiving of the at least one amount of the input force is further based on the receiving of the at least one input action.

12. The apparatus of claim 1, wherein the movable wheel of the movable pulley is associated with a movable wheel diameter, wherein the movable wheel diameter is greater than the predetermined distance for allowing wedging of the movable pulley against the first fixed pulley and the second fixed pulley in the first position, wherein unmovably pressing of the rope against the first wheel and the second wheel by the movable wheel is based on wedging.

13. An apparatus for facilitating controlled movement along a rope, the apparatus comprising:
a body comprising a first side plate and a second side plate spacedly disposed parallel to the first side plate forming an interior space;
a handle comprising a first handle portion and a second handle portion,
wherein a proximal end of the first handle portion is coupled with the first side plate and a proximal end of the second handle portion is coupled with the second side plate, wherein the apparatus is mountable using the handle for loading the rope, wherein a first end of the rope is secured to at least one immobile object;
a pulley assembly coupled with the body, wherein the pulley assembly comprises a first fixed pulley, a second fixed pulley, and a movable pulley, wherein the first fixed pulley and the second fixed pulley are fixedly disposed in the interior space and the movable pulley is movably disposed in the interior space, wherein the first fixed pulley opposes the second fixed pulley, wherein the movable pulley opposes the first fixed pulley and the second fixed pulley, wherein the movable pulley is configured to be disengaeably engageable with the first fixed pulley and the second fixed pulley, wherein a first channel is defined between a first wheel of the first fixed pulley and a movable wheel of the movable pulley and a second channel is defined between a second wheel of the second fixed pulley and the movable wheel based on opposably disposing of the movable pulley in relation to the first fixed pulley and the second fixed pulley, wherein the first fixed pulley is separated from the second fixed pulley by a predetermined distance defining a passageway between the first fixed pulley and the second fixed pulley, wherein the movable pulley is movable in the passageway in relation to the first fixed pulley and the second fixed pulley between a first position and at least one second position for disengaeably engaging the movable pulley with the first fixed pulley and the second fixed pulley, wherein the pulley assembly is configured for coupling with the rope, wherein the rope is wound around the movable wheel by passing the rope through the first channel and the second channel based on the coupling, wherein the movable pulley engages with the first fixed pulley and the second fixed pulley in the first position based on the loading, wherein the movable wheel unmovably presses the rope against the first wheel and the second wheel based on engaging of the movable pulley with the first fixed pulley and the second fixed pulley;
a link coupled with the movable pulley, wherein the link is configured for receiving at least one amount of an input force, wherein the link is configured for disengaging the movable pulley in at least a part from the first fixed pulley and the second fixed pulley by moving the movable pulley from the first position to the at least one second position based on the receiving of the at least one amount of the input force, wherein the movable wheel movably presses the rope against the first wheel and the second wheel with at least one amount of force for allowing moving the apparatus along a first length of the rope subsequent to the loading with at least one speed corresponding to the at least one amount of the input force based on the moving of the movable pulley in the passageway from the first position to the at least one second position; and
a control lever coupled to the body, wherein the control lever is rotatable about a pivot axis, wherein a distal end of the control lever is coupled with the link, wherein a proximal end of the control lever receives at least one first input force, wherein the control lever rotates from a first lever position to at least one second lever position about the pivot axis imparting the at least one amount of the input force to the link through the distal end of the control lever based on receiving the at least one first input force, wherein the receiving of the at least one amount of the input force is based on the imparting.

14. The apparatus of claim 13 further comprising at least one spring coupled with the control lever and the body, wherein a first end of the at least one spring is attached to the proximal end of the control lever and a second end is attached to at least one of the first side plate and the second side plate, wherein the at least one spring rotates the lever from the at least one second lever position to the first lever position after a removal of the at least one first input force.

15. The apparatus of claim 13, wherein the first fixed pulley is rotatable around a first axis perpendicular to at least one of the first side plate and the second side plate, wherein the second fixed pulley is rotatable around a second axis perpendicular to at least one of the first side plate and the second side plate, wherein the movable pulley is rotatable around a third axis perpendicular to at least one of the first side plate and the second side plate.

16. The apparatus of claim 13, wherein a first fixed end of a fixed axel of each of the first fixed pulley and the second fixed pulley is fixedly coupled to the first side plate and a second fixed end of the fixed axel of each of the first fixed pulley and the second fixed pulley is fixedly coupled to the second side plate, wherein a first movable end of a movable axel of the movable pulley is movably coupled with the first side plate and a second movable end of the movable axel of the movable pulley is movably coupled with the second side plate.

17. The apparatus of claim 13 further comprising a hanger coupled with the body, wherein the hanger is attached to a distal end of the body, wherein the hanger is configured for attaching at least one equipment to the body, wherein the loading of the rope is further based on the attaching.

18. The apparatus of claim 13 further comprising a spool stabilizer for a spool, wherein a second length of the rope is wound around the spool, wherein at least a portion of the second length of the rope is transformed to at least a portion of the first length of the rope by unwinding the at least one the portion of the second length of the rope, wherein the spool stabilizer is configured for preventing tangling of the at least the portion of the first length of the rope based on the unwinding of the at least one the portion of the second length of the rope.

19. The apparatus of claim 13, wherein at least one of the first handle portion and the second handle portion is configured for transitioning between an extended position and a collapsed position, wherein the first handle portion is parallelly disposed over the first side plate and the second handle portion is parallelly disposed over the second side plate in the collapsed position, wherein the first handle portion extends perpendicularly away from the first side plate and the second handle portion extends perpendicularly away from the second side plate in the extended position.

20. The apparatus of claim 13, wherein the movable wheel of the movable pulley is associated with a movable wheel diameter, wherein the movable wheel diameter is greater than the predetermined distance for allowing wedging of the movable pulley against the first fixed pulley and the second fixed pulley in the first position, wherein unmovably pressing of the rope against the first wheel and the second wheel by the movable wheel is based on wedging.
